(19) United States
(12) Patent Application Publication
(10) Pub. No.: US 2023/0382041 A1
(43) Pub. Date: Nov. 30, 2023

(54) ABLATIVE SUPPORT MATERIAL FOR DIRECTED ENERGY DEPOSITION ADDITIVE MANUFACTURING

(71) Applicant: Essentium IPCO, LLC, Pflugerville, TX (US)

(72) Inventor: Charles Brandon Sweeney, Pflugerville, TX (US)

(21) Appl. No.: 18/359,446

(22) Filed: Jul. 26, 2023

Related U.S. Application Data
(63) Continuation of application No. PCT/US22/13853, filed on Jan. 26, 2022.
(60) Provisional application No. 63/143,379, filed on Jan. 29, 2021.

(51) Int. Cl. B29C 64/153; B33Y 70/10

(52) U.S. Cl. CPC B29C 64/153; B33Y 70/10; B33Y 10/00

(57) ABSTRACT

An ablative support material for providing support to a primary material during a directed energy deposition (DED) process includes an ablative filler including a melting point that is at least about ten percent higher than a melting point of the primary material. The ablative support material is configured to provide mechanical support to the ablative support material during the DED process. The ablative support material includes an amount of the ablative filler that is at least equal to a mechanical percolation threshold of the ablative filler in the polymer binder.

### CROSS-REFERENCE TO RELATED APPLICATIONS

This application claims priority to U.S. Application No. 63/143,379 filed on Jan. 29, 2021, the teachings of which are incorporated herein by reference.

### FIELD

The present disclosure is directed to an ablative support material for directed energy deposition (DED) additive manufacturing.

### BACKGROUND

The statements in this section merely provide background information related to the present disclosure and may or may not constitute prior art.

Directed energy deposition (DED) refers to a category of additive manufacturing or three-dimensional printing techniques that involve a feed of powder or wire that is melted by a focused energy source to form a melted or sintered layer on a substrate. Although the focused energy source is usually a laser beam, a plasma arc or an electron beam may be used instead. The DED process is predominantly used with metals such as titanium, stainless steel, aluminum, and their alloys.

Much like scaffolding, support structures are used to provide mechanical support to a primary build structure during the additive manufacturing process and are subsequently removed from the primary build structure after processing, and support complex geometries such as overhangs, bridges, thin walls, and fine features that are part of the primary build structure. The material used for the support structure is distinct and different when compared to the material used for the primary build structure. In particular, the support structure material is specially formulated to provide reinforcement to the primary build structure, while still being easily removable from the primary build structure once the build process is complete. The support structure material used in a DED process should be able to resist relatively large dimensional changes when exposed to intense laser irradiance, infrared heat, and conducted heat that are generated during the DED process. The support structure should also be able to separate from the primary build structure without the assistance of a computer numerical control (CNC) cutting machine, a wire electrical discharge machine (EDM), or other equipment-intensive techniques. For example, the support structure may be removed from the primary build material using relatively light mechanical forces, vibratory energy, solvent dissolution, or solution-based etching.

Thus, while materials that are used for support structures used in additive manufacturing techniques achieve their intended purpose, there is a need for a new and improved materials for support structures used in DED processes.

### SUMMARY

According to several aspects, an ablative support material for providing support to a primary material during a directed energy deposition (DED) process is disclosed, and includes an ablative filler including a melting point that is at least about ten percent higher than a melting point of the primary material. The ablative support material is configured to provide mechanical support to the ablative support material during the DED process. The ablative support material includes an amount of the ablative filler that is at least equal to a mechanical percolation threshold of the ablative filler in the polymer binder.

In another aspect, a method for creating a part including a primary build structure and a support structure by a three-dimensional printer is disclosed. The method includes depositing, by a primary nozzle of the three-dimensional printer, a primary material onto a support structure to create the primary build structure of the part. The method also includes depositing, by a secondary nozzle of the three-dimensional printer, an ablative support material onto the support structure to create the secondary build structure of the part.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 a schematic diagram of a three-dimensional printer used in a DED process, where the three-dimensional printer employs a primary material and the disclosed ablative support material; and

FIG. 2 a schematic diagram illustrating the various components of the ablative support material.

### DETAILED DESCRIPTION

The following description is merely exemplary in nature and is not intended to limit the present disclosure, application, or uses.

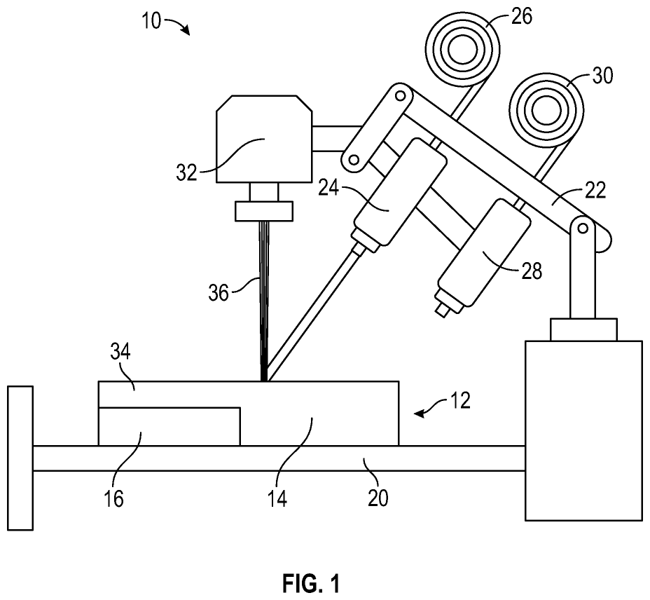

The present disclosure is directed to an ablative support material for a support structure used in a directed energy deposition (DED) process. Referring now to FIG. 1, a three-dimensional printer 10 for creating a part 12 based on the DED process is illustrated. The part 12 includes a primary build structure 14 as well as a support structure 16, where the support structure 16 is configured to provide structural support to the primary build structure 14 during the DED process. In the non-limiting embodiment as shown in FIG. 1, the three-dimensional printer 10 includes a build platform 20 for providing support to the part 12, an arm 22, a primary nozzle 24 configured to deposit a primary material 26, a secondary nozzle 28 configured to deposit an ablative support material 30, and an energy source 32. The primary material 26 is used to create the primary build structure 14 of the part 12 and may be any type of metal employed in a DED process such as, for example, titanium, stainless steel, aluminum, copper, nickel, Inconel, cobalt alloys, Zircalloy, tantalum, tungsten, niobium, molybdenum, and their alloys. The ablative support material 30 is used to create the support structure 16 of the part 12. In the example as shown in FIG. 1, the support structure 16 is used to provide mechanical support to an overhang 34 of the primary build structure 14. As explained below, the ablative support material 30 is configured to withstand the intense laser irradiance, infrared heat, and conducted heat that are generated during the DED process, while still being easily removable from the primary build structure 14 once the part 12 has been built completely.

In the exemplary embodiment shown in FIG. 1, the primary material 26 is fed to the primary nozzle 24 and is deposited onto the primary build structure 14 of the part 12. As the primary material 26 is deposited, a focused energy beam 36 generated by the focused energy source 32 melts the primary material 26 onto the primary build structure 14. In one embodiment, the focused energy beam 36 is a laser beam, however, it is to be appreciated that in another implementation the focused energy beam 36 may be a plasma arc or an electron beam. Similarly, the ablative support material 30 is fed to the secondary nozzle 28 and is deposited onto the support structure 16 of the part 12. As the ablative support material 30 is deposited, the focused energy beam 36 generated by the focused energy source 32 melts the ablative support material 30 onto the support structure 16.

In the embodiment as shown in FIG. 1, the primary material 26 and the ablative support material 30 are both in wire form, and the primary nozzle 24 and the secondary nozzle 28 are mounted to the arm 22. The arm 22 may be a multi-axis arm having four, five, or six axes. Although FIG. 1 illustrates separate nozzles 24, 28 for the primary material 26 and the ablative support material 30, it is to be appreciated that FIG. 1 is merely exemplary in nature and the disclosure is not limited to separate nozzles. For example, in an alternative embodiment, a dual head printer may be used to alternatively deposit the primary material 26 and the ablative support material 30. In another approach, a single nozzle may be used to deposit both the primary material 26 and the ablative support material 30 in alternating sequences. Furthermore, although FIG. 1 illustrates the primary material 26 in wire form, it is to be appreciated that the primary material 26 is not limited to a wire, and in another embodiment the primary material 26 may be in powder form. Moreover, although FIG. 1 illustrates the ablative support material 30 in wire form as well, it is to be appreciated that the ablative support material 30 is not limited to a wire, and may be dispensed any form that permits the ablative support material 30 to be deposited in a predetermined path during the DED process. For example, the ablative support material 30 may be dispensed as a filament from an extrusion print head, paste from a paste-dispensing nozzle, pellets from a pellet-fed extruder, or in a highly viscous form from a material jetting head. The ablative support material 30 may be in the form of a filament, pellet, paste, slurry, clay, or gel that is generally understood to flow in response to heat and or pressure.

The ablative support material 30 is configured to withstand the relatively rapid but intense heat generated by the focused energy beam 36 during the DED process. In addition to the heat generated by the focused energy beam 36, the ablative support material 30 is configured to withstand the blackbody infrared heat and conducted heat energy generated by a molten pool of the primary material 26 that is created during the DED process without a significant amount of distortion or other changes that may affect the ability of the support structure 16 to support the molten pool until solidification. Specifically, the ablative support material 30 is configured to withstand the melting temperature of the primary material 26, which may be as low as about 200° C. and as high as about 3,000° C. depending on the specific metal that is employed for the primary material 26. The ablative support material 30 is also configured to withstand the power generated by the focused energy beam 36, which ranges from about 200 Watts to about 2,000 Watts and includes a spot size ranging from about 100 microns to about 1 millimeter, depending upon the application. The ablative support material 30 is also configured to withstand the melt temperature of the primary material 26 and the energy generated by the focused energy beam 36 for a period of time that is dependent upon the deposition rate of the primary material 26, which ranges between about 10 millimeters/second to about 1 meter/second. Furthermore, the ablative support material 30 is also configured to withstand the radiated heat, the infrared heat, and the conductive heat that is created by the molten pool of the primary material 26. Specifically, the primary material 26 includes a heat capacity ranging from about 100 Joules/kilogram·Kelvin to about 2,000 Joules/kilogram·Kelvin and the ablative support material 30 is selected to withstand the residual heat energy associated with the cooling of the deposited primary bead and depends upon the specific type of primary material 26. It is to be appreciated that the heat capacity and the melting temperature of the primary material 26 both fully define an amount of residual heat energy that ablative support material 30 is required to dissipate, without experiencing deformation. For example, when lead is selected as the primary material 26 versus steel, this results in significantly different requirements for a potential ablative support material 30. Indeed, for a fixed volume of material, it is to be appreciated that lead includes about half the volumetric heat capacity (total heat energy) when compared to steel as well as a significantly lower melting point (1100° C.). Thus, the ablative support material 30 would not have to withstand nearly as much heat energy when lead is cooling when compared to steel.

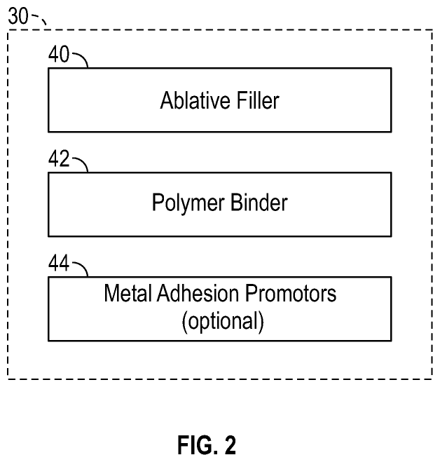

FIG. 2 is a schematic diagram illustrating the various components of the ablative support material 30. Specifically, the ablative support material 30 includes an ablative filler 40, a polymer binder 42, and one or more optional metal adhesion promotors 44. The ablative filler 40 includes glass, carbon, ceramic, silica, carbides, nitrides, clays, and mineral fillers that provide heat resistance to the ablative support material 30. The ablative filler 40 includes a melting point that is at least about ten percent higher than the melt temperature of the primary material 26, which ensures that the ablative support material 30 does not significantly melt during the DED process and is still able to provide mechanical support. The ablative filler 40 further acts as a heat refractory and withstands decomposition due to heat, as the ablative filler 40 is resistant against heat beyond the melt temperature of the primary material. The ablative filler 40 also includes a reflectivity to the wavelength of the visible light generated by the focused energy beam 36 and/or the infrared radiation emitted by the molten pool of the primary material 26 that is at least five percent higher when compared to the reflectivity of the primary material 26.

In one embodiment, the ablative filler 40 is soluble in a substance that the primary material 26 is insoluble within. Accordingly, when the part 12 (seen in FIG. 1) is placed within a solvent bath, the ablative support material 30 is dissolved, but the primary material 26 remains intact. For example, in one embodiment, the primary material 26 is stainless steel, and the ablative filler 40 of the ablative support material 30 is either an aluminum or a copper alloy. Accordingly, when the part 12 is placed in a solvent bath of sodium hydroxide or ferric chloride respectively, the ablative support material 30 is removed, however, the primary material 26 remains intact. In another embodiment, the ablative filler 40 is a relatively low thermal mass and thermally insulative material that promotes the slow cooling of the primary material 26. This strategy may allow for annealing of the primary metallic part and a slow relaxation of stress within the part. In another embodiment, the ablative filler 40 is a high thermal mass and thermally conductive material that rapidly quenches and cools the primary material 26 to promote smaller grain structures in a hardened state.

In one embodiment, the polymer binder 42 is a thermoplastic, a thermoset, or a wax configured to provide mechanical support to the ablative support material 30 during the deposition process. Accordingly, the polymer binder 42 includes a characteristic heat deflection temperature that is at least five percent greater than a respective heat deflection temperature of the primary material 26. It is to be appreciated that the ablative support material 30 includes an amount of the ablative filler 40 that is at least equal to a mechanical percolation threshold of the ablative filler 40 in the polymer binder 42 matrix or continuous phase. That is, the amount of ablative filler 40 in the ablative support material 30 is at a volume fraction where ablative filler particles physically interact with one other so that in the absence of the polymer binder 42 (i.e., when the polymer binder 42 is burned off during the DED process by the focused energy beam 36) the remaining ablative filler particles create a formation (i.e., the support structure 16) that supports the primary build structure 14. The mechanical percolation threshold represents a critical concentration of filler at which the ablative support material 30 begins to acquire the physical properties of the ablative filler 40. In the present example, the mechanical percolation threshold represents the critical concentration at which the ablative support material 30 begins to acquire a heat deflection temperature that is at least 5 percent above the temperature the ablative support material 30 is exposed to during the DED process. It is to be appreciated that the polymer binder 42 promotes the deposition and form of the ablative support material 30, and the combination of the ablative filler 40 and the polymer binder 42 includes a heat deflection temperature that is greater than the melting temperature of the primary material 26 either before or after exposure to the focused energy beam 36. It is also to be appreciated that the heating of the primary material 26 and the ablative support material 30 by the focused energy beam 36 is a dynamic process that occurs within the span of a few milliseconds, and therefore the heat deflection temperature of the ablative support material 30 may not be measured using traditional heat deflection temperature measurement tools.

In one alternative embodiment, the ablative support material 30 is constructed of just the polymer binder 42, where the polymer binder 42 is a pre-ceramic polymer that converts directly to a ceramic phase in response to experiencing the heat generated by the focused energy beam 36 (seen in FIG. 1). One example of a pre-ceramic polymer is polydimethylsiloxane (PDMS), which is converted into silicon carbide in response to experiencing the heat generated by the focused energy beam 36.

In one embodiment, the ablative support material 30 further includes the metal adhesion promotors 44. It is to be appreciated that the metal adhesion promotors 44 are optional and may be omitted in some embodiments. The metal adhesion promotors 44 are configured to create a bond between the primary material 26 (FIG. 1) and the ablative support material 30 having a bond strength that is ten percent or less than the cohesive strength of the primary material 26. The metal adhesion promotors 44 include at least one of a metallic filler, a ceramic wetting agent, and flux. For example, in one embodiment, the metallic filler the same metallic material as the primary material 26 in powder form. The ceramic wetting agent includes ceramics that are capable of being wetted by molten polymers. One non-limiting example of a ceramic wetting agent is alumina. The flux is also a wetting agent and may prevent oxidization of the primary material 26 (FIG. 1) during the deposition process. In one embodiment, the flux is welding flux that is employed in welding processes and includes a combination of carbonate and silicate materials.

Referring generally to FIGS. 1 and 2, the disclosed ablative support material provides various technical effects and benefits. Specifically, the ablative support material resists large dimensional changes in response to experiencing intense laser irradiation, infrared heat, and conducted heat created by the DED process. The disclosed ablative support material may be used to support the primary material and supports difficult to print geometries such as overhangs, bridges, thin walls, and relatively fine features. After the deposition process is complete, the ablative support material may be removed from the primary build structure relatively easily using light mechanical forces, vibratory energy, solution based etching, or other approaches that do not require the assistance of a CNC machine, an EDM, or other equipment-intensive techniques

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. An ablative support material for providing support to a primary material during a directed energy deposition (DED) process, the ablative support material comprising:
an ablative filler including a melting point that is at least about ten percent higher than a melting point of the primary material; and
a polymer binder configured to provide mechanical support to the ablative support material during the DED process, wherein the ablative support material includes an amount of the ablative filler that is at least equal to a mechanical percolation threshold of the ablative filler in the polymer binder.

2. The ablative support material of claim 1, wherein the mechanical percolation threshold represents a critical concentration of filler at which the ablative support material begins to acquire the physical properties of the ablative filler.

3. The ablative support material of claim 1, wherein the mechanical percolation threshold represents the critical concentration at which the ablative support material begins to acquire a heat deflection temperature that is at least five percent above the temperature the ablative support material is exposed to during the DED process.

4. The ablative support material of claim 1, wherein the ablative filler includes one or more of the following: glass, carbon, ceramic, silica, carbides, nitrides, clays, and mineral fillers.

5. The ablative support material of claim 1, wherein the ablative filler includes a melting point that is at least about ten percent higher than a melt temperature of the primary material.

6. The ablative support material of claim 1, wherein the ablative filler is soluble in a substance that the primary material is insoluble within.

7. The ablative support material of claim 1, wherein the polymer binder is a thermoplastic, a thermoset, or wax.

8. The ablative support material of claim 1, wherein the polymer binder includes a characteristic heat deflection temperature that is at least five percent greater than a respective heat deflection temperature of the primary material.

9. The ablative support material of claim 1, further comprising metal adhesion promotors configured to create a bond between the primary material and the ablative support material having a bond strength that is ten percent or less than a cohesive strength of the primary material.

10. The ablative support material of claim 9, wherein the metal adhesion promotors include at least one of a metallic filler, a ceramic wetting agent, and flux.

11. The ablative support material of claim 10, wherein the metallic filler is the same metallic material as the primary material in powder form.

12. The ablative support material of claim 10, wherein the ceramic wetting agent is alumina.

13. The ablative support material of claim 10, wherein the flux is welding flux that is employed in welding processes and includes a combination of carbonate and silicate materials.

14. The ablative support material of claim 10, wherein the ablative support material is a wire, powder, a filament, pellets, paste, slurry, clay, or gel.

15. A method for creating a part including a primary build structure and a support structure by a three-dimensional printer, the method comprising:
depositing, by a primary nozzle of the three-dimensional printer, a primary material onto a support structure to create the primary build structure of the part; and
depositing, by a secondary nozzle of the three-dimensional printer, an ablative support material onto the support structure to create the secondary build structure of the part.

16. The method of claim 15, wherein the method further comprises:
generating, by a focused energy source, a focused energy beam; and
melting the ablative support material by the focused energy beam.

17. The method of claim 16, wherein the method further comprises:
converting a polymer binder directly into a pre-ceramic phase in response to experiencing heat generated by the focused energy beam, wherein the ablative support material is constructed of just the polymer binder.

18. The method of claim 15, wherein the ablative support material includes an ablative filler including a melting point that is at least about ten percent higher than a melting point of the primary material and a polymer binder configured to provide mechanical support to the ablative support material during a DED process.

19. The method of claim 16, wherein that the ablative support material includes an amount of ablative filler that is at least equal to a mechanical percolation threshold of the ablative filler in the polymer binder.

20. The method of claim 19, wherein that the ablative support material includes metal adhesion promotors configured to create a bond between the primary material and the ablative support material having a bond strength that is ten percent or less than a cohesive strength of the primary material.
